(19) United States
(12) Patent Application Publication
(10) Pub. No.: US 2006/0146126 A1
(43) Pub. Date: Jul. 6, 2006

(54) Electronic smell emission method and its system for television and movie

(76) Inventor: Yixin Guo, Ronkonkoma, NY (US)

Correspondence Address: Yixin Guo, 256 Holbrook Avenue, Ronkonkoma, NY, 11779, US

(21) Appl. No.: 10/972,281

(22) Filed: Oct. 25, 2004

Related U.S. Application Data
(60) Provisional application No. 60/589,552, filed on Jul. 21, 2004.

(51) Int. Cl. H04N 7/18

(52) U.S. Cl. 348/61

(57) ABSTRACT

It is a kind of method and its system relating to the electronic smell emission for television programs and movies. The smell signal is mixed with video and audio signals in the contents of a television program, movie, electronic game and computer software. When these programs are playing, the smell signal is transmitted to an electronic smell emission device after such signals are received, detected and processed by the television receiver, movie projector, electronic game machine and computer. The electronic smell emission device operates a group of control valves through control circuit board and opens or closes a corresponding group to emit the same type of smell from the smell container which contain different types of smell to synchronize the video and audio contents in a television program, movie, electronic game and computer software and the emitted smell is then blown into the air by the fan. The present invention provides the smell effect corresponding to the contents of the picture in addition to the plentiful video and audio effects provided in the existing television shows, movies, electronic games and computer software so that viewers can actually sense the three-D effects of the sense of sight as well as the sense of hearing and the sense of smell in the process of viewing and entertainment and accordingly the enjoyment quality of television shows and movies as well as the entertainment effect of the electronic games will be further enhanced.

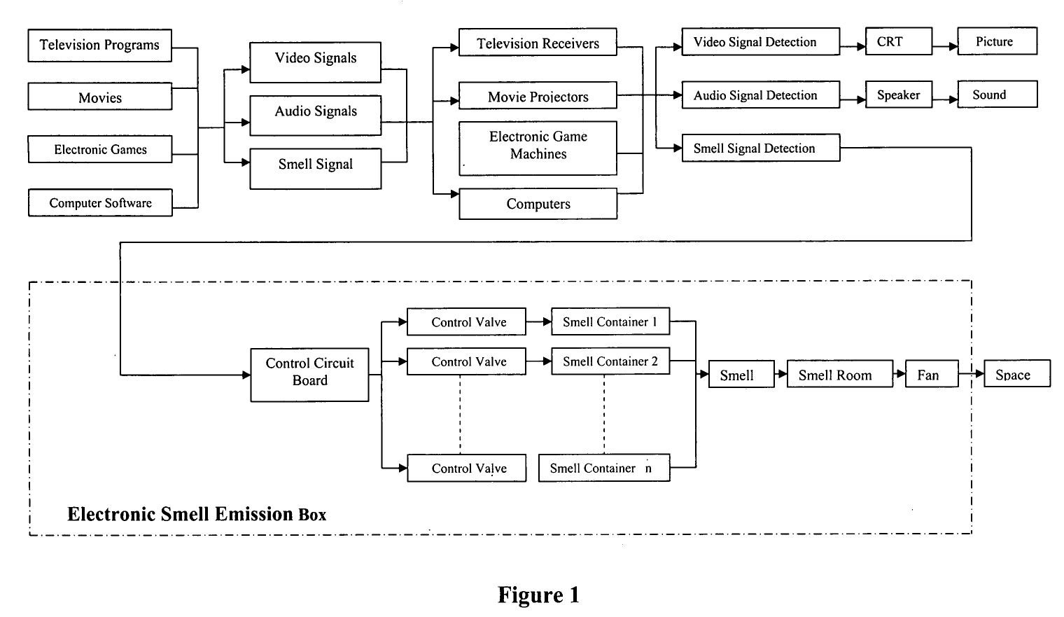

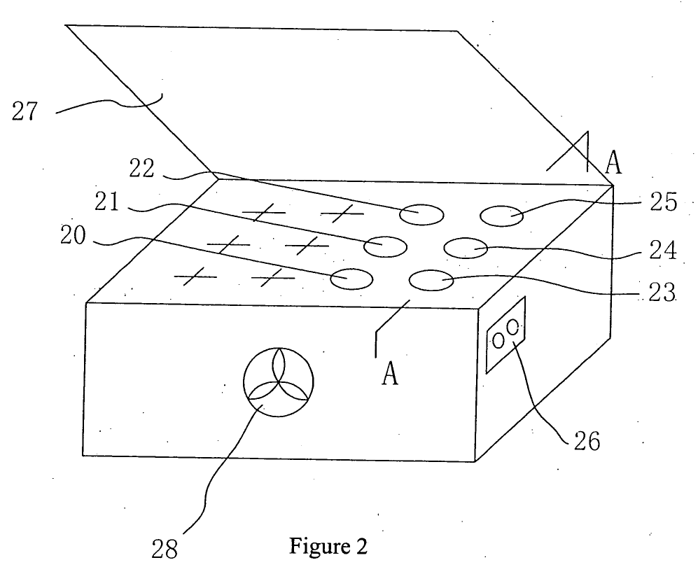

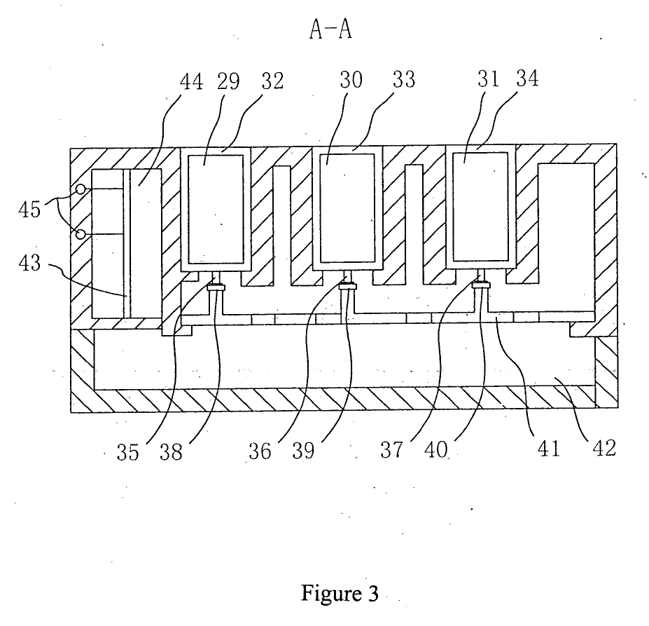

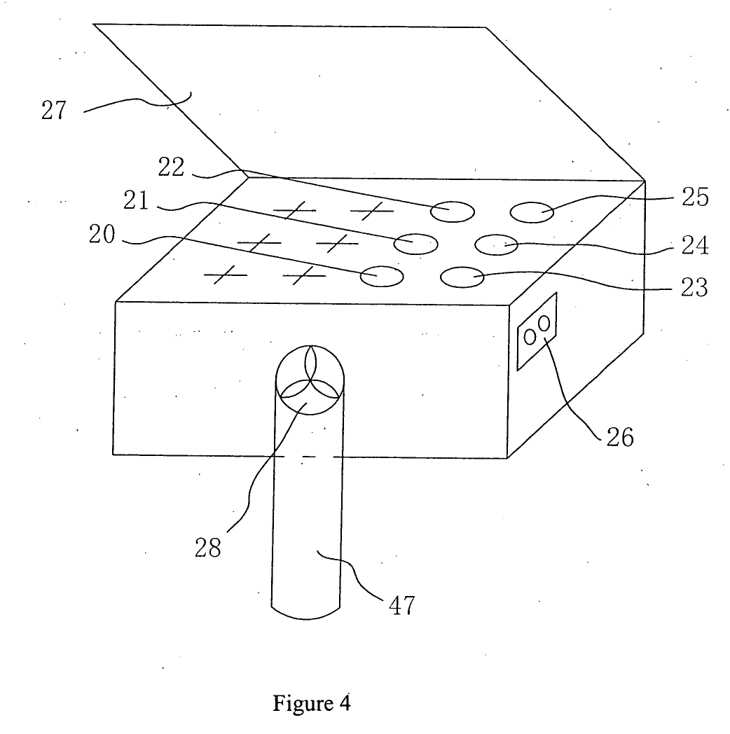

### FIELD OF THE INVENTION

This invention relates to a kind of smell information technology for television receiver, movie projector, electronic game machine and computer and more particularly to the method and its system in which the smell signal is mixed with video and audio signal in the existing contents in television shows, movies, electronic games and computer software. After the signal detection is done by the television receiver, movie projector, electronic game machine and computer, this kind of smell signal is transmitted to the electronic smell emission box through the output port to start the electromagnetic valve through the control circuit board and open the corresponding smell container opening and emit the smell that corresponds to the pictures on the screens of the television receiver, movie projector, electronic game machine and computer.

### BACKGROUND OF THE INVENTION

Nowadays, television, movie, electronic game and computer software program have become an indispensable part in people's lives. These programs not only bring the pleasure to the people, but also provide a great deal of knowledge and information. The conventional television, movie, electronic game and computer software programs have been focusing on developing the effect of the sense of sight and the sense of hearing. However, in addition to the sense of sight and the sense of hearing, people also need to be satisfied with the sense of feeling as well as the sense of smell and the sense of taste when receiving the information. If the ways to provide the information through television, movie, electronic game and computer software program are confined to the sense of sight and the sense of hearing only, people will be inevitably limited to enjoy these cultural and artistic effects.

As everyone knows, there has been no any cultural and artistic composition of television, movie, electronic game and computer software in the existing technology that offers the effect of the sense of smell at the same time when the effect of plentiful sense of sight and sense of hearing are offered. The major difficulty is that smell is a sort of chemical compound and its element composition is too complicated to be compounded immediately with several other single elements under general circumstance. Secondly, very few sensors can convert the smell into electrical signals at the present time. In terms of the input and output signals in the movie and television program, there is no any device that is able to receive or emit the smell signal. On the other hand, even though people have realized the function and effect of the sense of smell for a long time, the appropriate method of how to apply the sense of smell into movie and television programs that actually constitutes the three-D effect of the sense of sight as well as the sense of hearing and the sense of smell has not been discovered in the long time practice.

### SUMMARY OF THE INVENTION

This invention provides a kind of method and its system relating to the electronic smell emission for television and movie, etc. In addition to the plentiful video and audio effects provided in the existing television shows, movies, electronic games and computer software, it is the object of this invention to provide a smell effect corresponding to the contents on a picture so that people can be actually satisfied with the three-D effects of the sense of sight as well as the sense of hearing and the sense of smell in the process of viewing and entertainment and accordingly the enjoyment quality of television shows and movies as well as the entertainment effect of the electronic games will be further enhanced.

In order to accomplish the above object, the technical plan adopted by the present invention of the electronic smell emission method for television and movie is that a smell signal is mixed with video and audio signals in the original contents in a television program, movie, electronic game and computer software. This smell signal is transmitted together with the video and audio signals to an electronic smell emission device after such signals are received, detected and processed by the television receiver, movie projector, electronic game machine and computer. The electronic smell emission device operates a group of control valves through control circuit board and opens or closes a corresponding group to emit the same type of smell from the smell container which contains different types of smell to synchronize the video and audio contents in a television program, movie, electronic game and computer software and the emitted smell is then blown into the air by the fan.

The following is the explanation of the relevant content and change in the above-mentioned technical plan:

1. Said smells in the above plan include the scent of flowers, perfume smell, coffee smell, smell of a fried dish, fruit smell, smell of sourness, spicy smell, stinking smell, fishy smell, smoke and fire smells and ammunition smell.

2. In the above plan, in order to enhance the smell emission effect, the emitted smell can enter a smell room first and is blown into the air by a fan afterwards.

3. In the above plan, the smell in each said smell container can be the following types: the smell in each smell container is composed of the compressed gas of each different type of smell and the smell is emitted from the smell container when the control valve is opened.

4. In the above plan, the corresponding smell type, emission time, time length and intensity level are shown through the choice of different smell containers and the container opening time, time length and the opening size at the time of smell emission. This type of expression is programmed by the program card according to the contents required.

5. In the above plan, methods of digital-digital control, digital-analog control and analog-digital control are adopted in the whole smell emission control process ranging from the smell signal to control valve.

6. In the above plan, the emitted smell, in terms of large location such as the movie theater, is discharged through the suction port of the air conditioning or ventilation system or the special discharge port is separately installed.

In order to accomplish the above object, the technical plan adopted by the present invention of the electronic smell emission system for television and movie is explained in the following 3 parts:
a) Smell signal:
   This smell signal is mixed with video and audio signals in the original contents in a television program, movie, electronic game and computer software and is transmitted through the same transmission method.
b) The device of the smell signal reception, detection, processing and transmission.
   The corresponding device of the smell signal reception, detection, processing and transmission is added to the smell signal reception, detection, processing and output device of the television receiver, movie projector, electronic game machine and computer.
c) The electronic smell emission device
   A group of smell containers are installed in this device and each smell container comprises different types of smell. The smell containers are respectively disposed at each disposition space or at the corresponding location. There is a smell room in the device in where the inlet which connects each container opening is made. The control valve is respectively installed at each container opening. The outlet which connects the exterior space is also made in the smell room and a fan is installed at the outlet or in the smell room. The device is also equipped with the control circuit board which is a control circuit or a control unit that carries a CPU. Its input port receives the smell control signal transmitted from the television receiver, movie projector, electronic game machine and computer and its output port is connected respectively to the control end of each control valve.

The following is the explanation of the relevant content and change in the above-mentioned technical plan:

In the above plan, electromagnetic valve and hydraulic control component, pneumatic component or servo control component are used for said control valve. The choice of the control valve can be decided according to the requirement of the smell emission. For example, the best effect can be obtained if the servo control component is used when it is needed to control the opening size of the smell container.

The working principle of this invention is: the input port of the smell signal on the electronic smell emission device is connected to the output port of the smell signal on the television receiver, movie projector, electronic game machine and computer. Since the smell signal is mixed with the existing video and audio signals, these signals are transmitted to the electronic smell emission device to operate a group of electromagnetic valves through the control circuit board after such signals are received, detected and processed by the television receiver, movie projector, electronic game machine and computer. Since the smell signal that sets up the time to start the smell emission and what kind of smell should be emitted as well as the time to stop the smell emission can be programmed according to the contents when the television program, movie, electronic game and computer software are produced, and the compressed smell, under the function of the control valve, is emitted from the smell container and enters the smell room that has the buffering function for the emitted smell and the fan blows the smell in the smell room into the air, the smell is emitted synchronously corresponding to the contents of the picture and sound that appear on the screens of television, movie projector, electronic game machine and the computer.

Due to the adoption of the above technical plan, this invention has the following advantages and effects compared with the existing technology:

1. The present invention adds smell signal to the existing video and audio signals in the television programs, movies, electronic games and computer software, the sense of sight as well as the sense of hearing and the sense of smell are mixed together so that the enjoyment effect has been greatly improved.

2. Since the present invention adds the sense of smell to the electrical signal detection circuit and output technology of television, movie projector, electronic game machine and the computer, which have only the sense of sight and the sense of hearing, and the smell signal is outputted by the electronic smell emission device to form electronic smell emission system, the technical research, production and market of the television receiver, movie projector, electronic game machine, computer and electronic smell emission device will be developed towards a new field.

3. Since the present invention adds the sense of smell to the television programs, movies, electronic games and computer software that have only the sense of sight and the sense of hearing, the production of the television programs, movies, electronic games and computer software will be developed towards a new field.

### BRIEF DESCRIPTION OF THE DRAWINGS

DRAWING 1 is the block diagram the present invention

DRAWING 2 is the solid diagram of the application example of the electronic smell emission device.

DRAWING 3 is the A-A sectional view of DRAWING 2.

DRAWING 4 is the solid diagram of the electronic smell emission device used in the movie theater and other large locations.

In the above drawings, 20 to 25: disposition space of smell containers. 26: input port of the smell signal. 27: box cover. 28: fan. 29 to 31: smell storage space. 32 to 34: smell containers. 35 to 37: smell container openings. 38 to 40: electromagnetic valves. 41: baffle. 42: smell room. 43: control circuit board. 44: control circuit board installation space. 45: interior connection port. 46: smell channel.

### DETAIL DESCRIPTION

The following is the further description of the present invention in conjunction with the accompanying drawings and the application examples. It is a kind of method relating to the electronic smell emission for television programs and movies which corresponds to each television program, movie, electronic game and computer software to program the smell type, smell intensity, starting time and time length corresponding to the contents of the picture and the sound. The smell signal is mixed with video and audio signals in the original contents in a television program, movie, electronic game and computer software. This smell signal is transmitted together with the video and audio signals to an electronic smell emission device after such signals are received, detected and processed by the television receiver, movie projector, electronic game machine and computer. The electronic smell emission device operates a group of control valves through control circuit board and opens or closes a corresponding group to emit the same type of smell from the smell container which contains different types of smell to synchronize the video and audio contents in a television program, movie, electronic game and computer software and the emitted smell is then blown into the air by the fan.

The smell in each said smell container is composed of compressed gas with different smell types. The smell is emitted from the smell container when the control valve is opened. The smell in each smell container can be also composed of liquid with different smell types. When the control valve is opened, the smell liquid flown out or emitted is vaporized into gas by electrical heating in the smell room and is then blown into the air by the fan. The said smell include the scent of flowers, perfume smell, coffee smell, the smell of a fried dish, fruit smell, the smell of sourness, spicy smell, stinking smell, fishy smell, the smoke and fire smells and ammunition smell.

The corresponding smell type and emission time, time length and intensity level are shown through the choice of different smell containers and the container opening time, time length and the opening size at the time of smell emission. This expression is programmed according to the required contents when the television program, movie, electronic game and computer software are produced.

The control circuit board sets up the digital-analog conversion program of smell type and the digital-analog conversion program of smell intensity. It can also set up the digital control directly.

Referring to Drawing 1, when the television program, movie, electronic game and computer software contents that contain a video signal and an audio signal are playing, the television, movie projector, electronic game machine or computer would respectively receive, detect and process the video, audio and smell signals. The video signal is transmitted to CRT to show the picture. The audio signal is transmitted to the speaker to hear the sound and the smell signal is transmitted to the electronic smell emission device to sense the smell that the electronic smell emission system is formed.

Application Example: referring to Drawing 2 to 3, there is shown a kind of electronic smell emission system for television and movie which comprises the following three parts:
a) Smell signal:
   This smell signal is mixed with video and audio signals in the original contents in a television program, movie, electronic game and computer software and is transmitted through the same transmission method.
b) The device of the smell signal reception, detection, processing and transmission. The corresponding device of the smell signal reception, detection, processing and transmission device is added to the smell signal reception, detection, processing and output device of the television receiver, movie projector, electronic game machine and computer.
c) The electronic smell emission box comprises the space to dispose several smell containers 20 to 25, smell containers 32 to 34, electromagnetic valves 38 to 40, control circuit board 43, fan 28, smell room 42, smell signal input port 45 and the switch. The smell containers 32 to 34 are disposed respectively in the smell container space 20 to 25. The smell containers 32 to 34 contain different types of smell. The smell room 42 is a buffering space where the inlet that connects each smell container opening 35 to 37 is installed. The electromagnetic valves 38 to 40 are respectively installed at the smell container opening 35 to 37. The outlet that connects the exterior space in installed in the smell room 42. The fan is installed at the outlet. The control circuit board 43 is a control circuit or a control unit that carries a CPU. Its smell signal input port 26 receives the smell control signal transmitted from the television receiver, movie projector, electronic game machine and computer and its output port is respectively connected to the control end of each electromagnetic valve 38 to 40.

In this application, the space to dispose 24 or 36 or more smell containers can be arranged. As shown in Drawing 2, only part of the smell container space 20 to 25 is shown in this drawing. The different types of smell are stored in the smell storage space 29 to 31 in the smell container. Referring to Drawing 3, the smell containers 32 to 34 are disposed respectively in the smell container space 23 to 25. The smell container can be used for one time only or for many times. The smell can be the scent of flowers, perfume smell, coffee smell, the smell of a fried dish, fruit smell, the smell of sourness, spicy smell, stinking smell, fishy smell, smoke and fire smells and ammunition smell and it can be also the special made smells. In response to the inputted smell signal, the control circuit board 43 controls the smell containers with different numbers 32 to 34 to emit the smell through the electromagnetic valves 38 to 40. Smell is composed of compressed gas so that it can be emitted from the smell containers 32 to 34 with enough pressure to enter the smell room 42 through the spaced baffle to be blown into the air by the fan 28.

The smell storage space should be numbered and different smell containers should be disposed according to the numbers. Different smell containers should be used according to the contents in different television programs, movies, electronic games and computer software contents. For example, smell container No. 1 is Type A perfume smell. Smell container No. 2 is Type B perfume smell. Smell container No. 3 is jasmine smell and smell container No. 4 is coffee smell. Users can buy the standard smell containers in the market and dispose them at the designated storage space according to the numbers. Certainly, the smell emission box is also a product which can be purchased in the market, especially the uniform standard size of the smell container storage space should be set up. In addition, the smell container emission box can also have some spare storage space so as to put in the smell containers that contain special smells.

The smell emission time, smell type, intensity and the duration of the smell emission are programmed corresponding to the contents in the television programs, movies, electronic games and computer software. The output port for the smell signal reception, detection and processing should be accordingly installed on the television receiver, movie projector, electronic game machine and computer.

As shown in Drawing 3, when the smell signal input port 26 of the electronic smell emission box is connected to the smell signal output port on the television receiver, movie projector, electronic game machine and computer, the smell signal is transmitted to the control circuit board 43 though smell signal input port 26 and interior connection port. The control circuit board 43 controls the respective electromagnetic valves 38, 39 and 40 to open the valves and the smells are emitted separately from the container openings 35, 36 and 37 of the smell containers 32, 33 and 34. The signal also controls the opening size of the electromagnetic valve to control the smell intensity. For example, if jasmine is displayed on the screens of television, movie projector, electronic game machine and computer 20 minutes after the program starts, the smell signal outputted from the television receiver, movie projector, electronic game machine and computer into the electronic smell emission box would transmit the smell signal through the control circuit board 43 to open the smell container No. 3 and emit the jasmine smell (smell is “weak”) for 3 minutes. After 30 minutes, the scene of drinking coffee is displayed on the screens of the television receiver, movie projector, electronic game machine and computer. At this time, the smell signal is transmitted from the output port of the television receiver, movie projector, electronic game machine and computer to the input port of the electronic smell emission box to open the smell container No. 4 and emit the coffee smell (smell is “strong”) for 5 minutes. The smell is blown into the air by the fan 28 from the smell room 42.

When a program is playing, the smell signals in television, movie projector, electronic game machine and computer are all programmed to set up the smell emission type and the time length corresponding to the contents in television programs, movies, electronic games and computer software. The smell signal is transmitted from the smell signal output port of the television receiver, movie projector, electronic game machine and computer into the control circuit board 43 which then transmits the signal to the corresponding electromagnetic valve to open the corresponding smell container and emit the corresponding smell. The analog electrical circuit board, digital-analog electrical circuit board or analog-digital electrical circuit board can be also used to save the program information.

The following is the example of the digital circuit on the control circuit board:

The Smell Type Digital Program Setting

| | | |
|---|---|---|
| 0000 | 0000 | Natural Air |
| No. 1 | 0000 0001 | Start Electromagnetic Valve of Type A Perfume Smell |
| No. 2 | 0000 0010 | Start Electromagnetic Valve of Type B Perfume Smell |
| No. 3 | 0000 0011 | Start Electromagnetic Valve of Jasmine Smell |
| No. 4 | 0000 0100 | Start Electromagnetic Valve of Coffee Smell |

The Smell Intensity Digital Program Setting

| | | |
|---|---|---|
| 1000 | 0000 | Stop Electromagnetic Valve |
| 1000 | 0001 | “Weak” Smell (Relatively Small Opening of |
| | | Electromagnetic Valve) |
| 1000 | 0010 | “Relatively Strong” Smell (Relatively Big Opening of |
| | | Electromagnetic Valve) |
| 1000 | 0011 | “Strong” Smell (Big Opening of Electromagnetic Valve) |
| 1000 | 0100 | “Very Strong” Smell (Very Big Opening of |
| | | Electromagnetic Valve) |

The above control circuit board comprises two groups of number settings for smell type and smell intensity. The upper 4 groups of numbers indicate 4 different smell containers (0000 0000 is natural air) and the lower 4 groups of numbers indicate the opening size of the electromagnetic valve (1000 0000 is stop start-up). The control circuit board programs the digital-analog conversion for the smell type and the digital-analog conversion for the smell intensity. It can also program the digital control directly.

The following is the example of the digital-digital smell signal programmed for the working principle of the contents in a program:
T1=0 (minute)
0000 0000 Natural Air
1000 0000 Stop Electromagnetic Valve
T2=20 (minute)
0000 0011 Start Electromagnetic Valve of Jasmine Smell (No. 3)
1000 0001 “Weak” Smell
T3=23 (minute)
0000 0000 Natural Air
1000 0000 Stop Electromagnetic Valve
T4=30 (minute)
0000 0100 Start Electromagnetic Valve of Coffee Smell (No. 4)
1000 0011 “Strong” Smell
T5=35 (minute)
0000 0000 Natural Air
1000 0000 Stop Electromagnetic Valve

Contents in one program above are programmed: 20 minutes after the program starts, jasmine is displayed on the screen. The smell is “weak” and the time is 3 minutes. After 30 minutes, the scene of drinking coffee is displayed on the screen. The smell is “strong” and the time is 5 minutes. The smell signal is a group of digital signals which direct the digital circuit on the control circuit board to transmit the corresponding signal which, 20 minutes after the program starts, starts No. 3 electromagnetic valve of the jasmine smell container and emit “weak” jasmine smell for 3 minutes. After 30 minutes, the No. 4 electromagnetic valve of the coffee smell container starts working to emit “strong” coffee smell for 5 minutes. The smell emission time and smell type correspond to the contents of the picture.

The electromagnetic valve can be used if the smell signal is programmed as no smell and no intensity. If the smell signal is programmed as having the smell and intensity, the special electromagnetic valve should be used, such as servo system electromagnetic valve.

The smell container can be disposed upside down in the smell container disposition space and can be also disposed upright in the smell container disposition space.

The large electronic smell emission device used in the movie theater can be disposed outside the movie theater if there is no space to be disposed inside. As shown in Drawing 4, the smell should enter into the theater through the smell suction port 46 at this time and the smell ventilation outlet should be installed at different locations in the movie theater like the ones of the air conditioning system. Also, the smell can also enter into the movie theater through the conduit and ventilation outlet of the air conditioning system. In terms of the large synchronized electronic smell emission box, the smell container can be disposed outside the electronic smell emission box.

### References Cited (Referenced By)

| | | | |
|---|---|---|---|
| 5398070 | Mar. 14, 1995 | Lee | 348/553 |

1. It is a kind of method relating to the electronic smell emission for television programs and movies. The characteristic of the electronic smell emission method is that a smell signal is mixed with video and audio signals in the original contents in a television program, movie, electronic game and computer software. This smell signal is transmitted together with the video and audio signals to an electronic smell emission device after such signals are received, detected and processed by the television receiver, movie projector, electronic game machine and computer. The electronic smell emission device operates a group of control valves through control circuit board and opens or closes a corresponding group to emit the same type of smell from the smell container which contains different types of smell to synchronize the video and audio contents in a television program, movie, electronic game and computer software and the emitted smell is then blown into the air by the fan.

2. As described in claims 1, the characteristic of the electronic smell emission method is that the emitted smell enters a smell room first and is blown into the air by the fan afterwards.

3. As described in claims 1, the characteristic of the electronic smell emission method is that said smell in each smell container is composed of compressed gas of different types of smell and the smell is emitted from the smell container when the control valve is opened.

4. As described in claims 1, or 2 and 3, the characteristic of the electronic smell emission method is that the corresponding smell type, emission time, time length and intensity level are shown through the choice of different smell containers and the container opening time, time length and the opening size at the time of smell emission. This expression is programmed according to the contents required when the television program, movie, electronic game and computer software are produced.

5. As described in claims 1, the characteristic of the electronic smell emission method is that methods of digital-digital control, digital-analog control and analog-digital control are adopted in the whole smell emission control process ranging from the smell signal to control valve.

6. As described in claims 1, the characteristic of the electronic smell emission method is that the emitted smell, in terms of large location such as the movie theater, is discharged through the suction port of the air conditioning or ventilation system and that the special discharge port is separately set up.

7. It is a kind of device relating to the electronic smell emission system associated with television program and movie. The characteristic of the electronic smell emission method is explained in the following 3 parts:
a) Smell signal:
This smell signal is mixed with video and audio signals in the original contents in a television program, movie, electronic game and computer software and is transmitted through the same transmission method. b) The device of the smell signal reception, detection, processing and transmission.
The corresponding device of the smell signal reception, detection, processing and transmission is added to the smell signal reception, detection, processing and output device of the television receiver, movie projector, electronic game machine and computer.
c) The electronic smell emission device
A group of smell containers are installed in this device and each smell container comprises different types of smell. The smell containers are respectively disposed at each storage space or at the corresponding location.
There is a smell room in the device in where the inlet which connects each container opening is made. The control valve is respectively installed at each container opening. The outlet which connects the exterior space is also made in the smell room and a fan is installed at the outlet or in the smell room.
The device is also equipped with the control circuit board which is a control circuit or a control unit that carries a CPU. Its input port receives the smell control signal transmitted from the television receiver, movie projector, electronic game machine and computer and its output port is connected respectively to the control end of each control valve.

8. As described in claims 8, the characteristic of the electronic smell emission method is that electromagnetic valve and hydraulic control components, pneumatic components or servo control components are used for said control valves.
